(19) United States
(12) Patent Application Publication
(10) Pub. No.: US 2021/0232378 A1
(43) Pub. Date: Jul. 29, 2021

(54) PROGRAM CALLING, ELECTRONIC DEVICE, AND STORAGE MEDIUM

(71) Applicant: BEIJING SANKUAI ONLINE TECHNOLOGY CO., LTD, Beijing (CN)

(72) Inventors: Zhiyu WANG, Beijing (CN); Zhen XU, Beijing (CN); Yi JIANG, Beijing (CN)

(21) Appl. No.: 17/059,981

(22) PCT Filed: Dec. 14, 2018
(86) PCT No.: PCT/CN2018/121032

§ 371 Date: Nov. 30, 2020

(30) Foreign Application Priority Data
May 31, 2018 (CN) 201810550126.4

(51) Int. Cl. G06F 8/41; G06F 9/445

(52) U.S. Cl. CPC G06F 8/433; G06F 8/437; G06F 8/42; G06F 9/44505

(57) ABSTRACT

The present disclosure provides a program calling method. The method includes: loading dependency relationship data in binary data of a program into a runtime environment in response to calling to a first element in an execution process of the program, where the dependency relationship data includes an index key and an index value; obtaining the index value from the dependency relationship data, the index value corresponding to a second element, the first element depending on the second element; and calling the second element corresponding to the index value.

### CROSS REFERENCE TO RELATED APPLICATIONS

The present disclosure is a national stage of an international application No. PCT/CN2018/121032, filed on Dec. 14, 2018 and entitled “PROGRAM CALLING DECOUPLING”, and the international application claims priority to Chinese Patent Application No. 201810550126.4, filed on May 31, 2018 and entitled “PROGRAM CALLING DECOUPLING METHOD AND APPARATUS, ELECTRONIC DEVICE, AND STORAGE MEDIUM.” Both applications are incorporated herein by reference in their entirety.

### TECHNICAL FIELD

The present disclosure relates to the technical field of computers, and in particular, to a program calling method, an electronic device, and a storage medium.

### BACKGROUND

In a software development process, when there is a dependency relationship between software modules or functions, there is inevitably coupling between the software modules or functions. However, in theory, absolute zero coupling is impracticable, but a coupling degree can be reduced by using some methods. For example, a +load method is generally used as a first choice for decoupling information injection.

### SUMMARY

According to an aspect, embodiments of the present disclosure provide a program calling method. A program corresponds to binary data, and the binary data includes dependency relationship data. The method includes: loading the dependency relationship data in the binary data of the program into a runtime environment in response to calling to a first element in the program in an execution process of the program, where, the dependency relationship data at least includes an index key corresponding to the first element and an index value associated with the index key; obtaining the index value associated with the index key from the dependency relationship data through the runtime environment, the index value corresponding to a second element, the first element depending on the second element; and calling the second element corresponding to the index value.

According to another aspect, the embodiments of the present disclosure provide a program calling apparatus. A program corresponds to binary data, and the binary data includes dependency relationship data. The apparatus includes: a dependency relationship data loading module, an index value determining module, and a calling module.

The dependency relationship data loading module is configured to load the dependency relationship data in the binary data of the program into a runtime environment in response to calling to a first element in the program in an execution process of the program, where the dependency relationship data at least includes an index key corresponding to the first element and an index value associated with the index key.

The index value determining module is configured to obtain the index value associated with the index key from the dependency relationship data loaded by the dependency relationship data loading module through the runtime environment, the index value corresponding to a second element, the first element depending on the second element.

The calling module is configured to call the second element corresponding to the index value determined by the index value determining module.

According to another aspect, the embodiments of the present disclosure further provide an electronic device, including a memory and a processor. The memory stores a computer program runnable on the processor, the program corresponds to binary data, the binary data includes dependency relationship, and the processor, when executing the program, performs the following operations: loading the dependency relationship data in the binary data of the program into a runtime environment in response to calling to a first element in the program in an execution process of the program, where the dependency relationship data at least includes an index key corresponding to the first element and an index value associated with the index key; obtaining the index value associated with the index key from the dependency relationship data through the runtime environment, the index value corresponding to a second element, the first element depending on the second element; and calling the second element corresponding to the index value.

According to another aspect, the embodiments of the present disclosure provide a computer-readable storage medium, storing a computer program. The program corresponds to binary data, the binary data includes dependency relationship, and the following operations are performed when the program is executed by a processor: loading the dependency relationship data in the binary data of the program into a runtime environment in response to calling to a first element in the program in an execution process of the program, where the dependency relationship data at least includes an index key corresponding to the first element and an index value associated with the index key; obtaining the index value associated with the index key from the dependency relationship data through the runtime environment, the index value corresponding to a second element, the first element depending on the second element; and calling the second element corresponding to the index value.

### BRIEF DESCRIPTION OF THE DRAWINGS

To describe the technical solutions in embodiments of the present disclosure more clearly, the following briefly describes accompanying drawings required for describing the embodiments. Apparently, the accompanying drawings in the following description show merely some embodiments of the present disclosure, and a person of ordinary skill in the art can still derive other drawings from these accompanying drawings without creative efforts.

FIG. 1 is a flowchart of a program calling decoupling method according to an embodiment of the present disclosure.

FIG. 2 is a flowchart of a program calling decoupling method according to an embodiment of the present disclosure.

FIG. 3 is a schematic structural diagram of a program calling decoupling apparatus according to an embodiment of the present disclosure.

FIG. 4 is another schematic structural diagram of a program calling decoupling apparatus according to an embodiment of the present disclosure.

FIG. 5 is a schematic structural diagram of an electronic device according to an embodiment of the present disclosure.

### DETAILED DESCRIPTION

The following clearly and completely describes the technical solutions in embodiments of the present disclosure with reference to accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

In the related art, using the +load method causes a dynamic loader to load a class corresponding to the dependency relationship in advance when a program starts. Consequently, a startup time of the program is extended. To address at least some of the above issues, the embodiments of the present disclosure provide a program calling decoupling method (that is, a program calling method), which is described below in detail.

A program calling decoupling method disclosed in this embodiment is shown in FIG. 1. The method includes step 110 to step 130.

Step 110: An electronic device loads the dependency relationship data in the binary data of the program into a runtime environment in response to calling to a first element in the program in an execution process of the program.

In step 110, the dependency relationship data at least includes: an index key corresponding to the first element, and an index value corresponding to a second element, where the second element is an element on which the first element depends.

The index value refers to an index value associated with the index key.

The program described in the embodiments of the present disclosure has corresponding binary data (that is, the program corresponds to binary data), and the binary data includes dependency relationship data. The first element and the second element described in the embodiments of the present disclosure are used for representing two different elements. Each element may be: a function, a class, a method, a character, a character string, or the like that the program needs to access in a running process. The first element is an element that may be executed by only depending on another element. The second element is an element on which the first element depends. For example, if a function A needs to depend on a character string B in an execution process, A is a first element, and B is a second element.

In some embodiments, in binary data of a current program, for example, in an executable file of the current program obtained through compilation, dependency relationship data between elements called by the current program during running is written in advance. Generally, the dependency relationship data is stored in the form of key-value pair according to a preset format. Data corresponding to the first element in the dependency relationship data is used as an index key. Data corresponding to the second element on which the first element depends is used as an index value. The index value is also referred to as the index value associated with the index key. In some embodiments, the dependency relationship data may further include type information about the index value.

In an execution process of the program, when the first element needs to be called, a runtime environment of the current program loads the dependency relationship data in the binary data of the program into the runtime environment through a method for calling and reading a binary segment.

Step 120: The electronic device obtains the index value associated with the index key corresponding to the first element from the dependency relationship data through the runtime environment.

The index value corresponds to the second element, and the first element depends on the second element.

After reading the dependency relationship data in the binary data, the runtime environment may parse the dependency relationship data according to the preset format, and determine index keys corresponding to first elements having a dependency relationship and called in an execution process of the program, and one or more index values corresponding to each index key.

Step 130: The electronic device calls the second element corresponding to the index value.

In some embodiments, the runtime environment of the current program further parses the dependency relationship data according to the index value to obtain the second element corresponding to the index value, and calls the second element. In some embodiments, the dependency relationship data may further include a second element type corresponding to the index value. The runtime environment further parses the dependency relationship data according to the index value and the second element type.

In the program calling decoupling method in the embodiments of the present disclosure, dependency relationship data of the program during running is written into binary data of the program in advance. Therefore, the dependency relationship data is loaded only when elements having a dependency relationship need to be called, thereby effectively shortening the startup time of the program, and effectively improving the startup efficiency of the program.

A program calling decoupling method disclosed in this embodiment is shown in FIG. 2. The method includes step 210 to step 250.

Step 210: The electronic device generates, according to an index key corresponding to a first element and a second element on which the first element depends in a program, dependency relationship data associating the index key with an index value corresponding to the second element.

In some embodiments, before the dependency relationship data in the binary data of the program is loaded into a runtime environment in response to calling to the first element in the program in an execution process of the program, the method further includes: generating, according to the index key corresponding to the first element and the second element on which the first element depends in the program, the dependency relationship data associating the index key with the index value corresponding to the second element; and writing the dependency relationship data into the binary data generated after the program is compiled.

The first element and the second element in the embodiments of the present disclosure are used for representing two different elements. Each element may be: a function, a class, a method, a character, a character string, or the like that the program needs to call in a running process. The first element is an element that may be executed by only depending on another element. The second element is an element on which the first element depends.

In some embodiments, for different element types, methods for generating dependency relationship data are different. The generating, according to the index key corresponding to the first element and the second element on which the first element depends in the program, the dependency relationship data associating the index key with the index value corresponding to the second element includes at least one of the following items: if the second element is a function, the dependency relationship data associating the index key with the index value is generated by using a pointer of the second element as the index value of the second element; if the second element is a character string, the dependency relationship data associating the index key with the index value is generated by using the second element itself as the index value of the second element; if the second element is a class, the dependency relationship data associating the index key with the index value is generated by using a name of the second element as the index value of the second element; and if the second element is a method of Objective-C, the dependency relationship data associating the index key with the index value is generated by using a character string obtained through a system macro as the index value of the second element.

Specific solutions of generating the dependency relationship data for different element types are respectively described below. In a first solution, the second element on which the first element depends is a function of C language.

First, a data format of the dependency relationship data is defined. During specific implementation, the dependency relationship data at least includes an index key and an index value. In an embodiment, the dependency relationship data may further include a type of the second element corresponding to the index value, whether the second element corresponding to the index value is an array, or other information. Therefore, for example, the dependency relationship data may be defined to have the following structure:

typedef struct _KLN_DATA_HEADER {

const void *key;
const KLN_TYPE type;
const BOOL isArray;

} KLN_DATA_HEADER;
typedef struct _KLN_DATA {

const KLN_DATA_HEADER header;
const void *value;

} KLN_DATA.

In the foregoing data structure definition, the dependency relationship data includes two parts. The first part is a data header. The second part is a data body. In the data header, the key represents the index key corresponding to the first element, the type represents the type of the second element, and the “isArray” represents whether the second element is an array. In the data body, the value represents the index value corresponding to the second element.

A value of each element in the foregoing data structure is determined according to a pre-appointment and a compiled file of the current program. For example, the values of key and the second element are determined according to a dependency appointment; and the value may be determined, according to the binary data obtained after the program is compiled, by executing a compilation directive.

When the second element is a function, the pointer of the second element is used as the index value of the second element. That is, the value taken is the pointer of the second element, which may be obtained from the binary data obtained through compilation. Then, the dependency relationship data associating the index key with the index value is generated. The value of type in the generated dependency relationship data is used for indicating that the second element type corresponding to the index value is a function.

In a second solution, the second element on which the first element depends is a method of Objective-C.

When the second element is a method of Objective-C, a character string composed of a name, a class name, and a method type of the second element may be obtained through a system macro_func_, and then the character string is used as the index value of the second element; and finally, the dependency relationship data associating the index key with the index value is generated. In some embodiments, if the structure of the dependency relationship data is as described above, the value of type in the generated dependency relationship data is used for indicating that the second element type corresponding to the index value is a method of Objective-C.

In a third solution, the second element on which the first element depends is a character string.

When the second element is a character string, the character string is directly used as the index value of the second element; and then, the dependency relationship data associating the index key with the index value is generated. In some embodiments, if the structure of the dependency relationship data is as described above, the value of type in the generated dependency relationship data is used for indicating that the second element type corresponding to the index value is a character string.

In a fourth solution, the second element on which the first element depends is a class.

When the second element is a class, a name of the class is directly used as the index value of the second element; and then, the dependency relationship data associating the index key with the index value is generated. In some embodiments, if the structure of the dependency relationship data is as described above, the value of type in the constituted dependency relationship data is used for indicating that the second element type corresponding to the index value is a class.

The decoupling method related to the present disclosure is not limited to dependency relationships between the several following type elements. Description is made by using only the several following types as an example in this embodiment.

The methods for determining dependency relationship data of non-array types are described above. If the structure of the dependency relationship data is as described above, a value of isArray in the constituted dependency relationship data is used for indicating that the second element is non-array. In other embodiments, one index key may further correspond to a plurality of index values. The plurality of index values are stored in the form of array. In some embodiments, if the structure of the dependency relationship data is as described above, the value of isArray in the generated dependency relationship data is used for indicating that the second element is an array.

Step 220: The electronic device writes the dependency relationship data into binary data generated after the program is compiled.

In some embodiments, in step 220, the writing the dependency relationship data into binary data generated after the program is compiled includes: writing the dependency relationship data into the binary data generated after the program is compiled by using a writing method for calling a binary segment through a compilation directive. For example, a writing macro _KLN_DATA_DEFINE( ) is pre-defined, and after receiving writing information, _KLN_DATA_DEFINE( ) performs writing by using _attribute_(section( )). A macro definition is shown as follows:

#define _KLN_DATA_DEFINE(HEADER, VALUE)\

_attribute_((used, section(KLN_SEGMENT_SECTION))) static const KLN_DATA KLN_UNIQUE_IDENTIFIER=(KLN_DATA) {HEADER, VALUE}.

In the foregoing micro definition, KLN_SEGMENT_SECTION is a data segment into which dependency relationship data KLN_DATA is written. HEADER represents a data header of the dependency relationship data. VALUE represents a data body of the dependency relationship data.

In some embodiments, the data segment is generally divided into a _DATA segment and a _TEXT segment. Each segment may have a plurality of Sections. In the present disclosure, the dependency relationship data is written into a preset Section in the _DATA segment.

Step 230: The electronic device loads the dependency relationship data in the binary data of the program into a runtime environment in response to calling to a first element in the program in an execution process of the program.

In some embodiments, in step 230, the loading the dependency relationship data in the binary data of the program into a runtime environment in response to calling to a first element in the program in an execution process of the program includes: obtaining an operation of calling the first element in the program; and obtaining the dependency relationship data in the binary data of the program in response to the operation through a preset binary segment reading function.

In some embodiments, in a running process of the current program, when an element to be executed in dependence on other elements is called, for example, the current program runs to call the first element, because the first element is to be executed in dependence on the second element, the first element may call and query a runtime environment of the current program through an index key.

The runtime environment obtains the dependency relationship data in the binary data of the program in response to the query operation of the first element through a preset binary segment reading function. Using an iOS platform as an example, the runtime environment may read data of a data segment where the dependency relationship data is located into an internal memory by calling a binary segment reading function provided in a macho library.

In some embodiments, after obtaining the operation of calling the first element in the program, the runtime environment may further load, according to index keys of all first elements depending on other elements in the current program, all dependency relationship data corresponding to all of the first elements into the internal memory.

Step 240: The electronic device obtains the index value associated with the index key corresponding to the first element from the dependency relationship data through the runtime environment.

In the embodiments of the present disclosure, the dependency relationship data at least includes: an index key corresponding to the first element, and an index value corresponding to a second element. The first element depends on the second element. After loading the dependency relationship data into the internal memory, the runtime environment parses the dependency relationship data according to a data format of the dependency relationship data, and determines one or more pieces of information such as index keys corresponding to the first elements having a dependency relationship and called in an execution process of the program, index values corresponding to the index keys, second element types corresponding to the index values, and whether second elements corresponding to the index values are an array. Then, the index values corresponding to the index keys are queried in the dependency relationship data obtained through parsing. During specific implementation, the runtime environment queries the dependency relationship data where the index keys are located, and determines the index values in the dependency relationship data.

Step 250: The electronic device calls the second element corresponding to the index value.

Further, the dependency relationship data where the index key is located further includes the second element type corresponding to the index value. The runtime environment parses the index value according to preset index value declaration corresponding to the second element type, and determines the second element corresponding to the index value. Then, the second element corresponding to the index value is called. For example, when the dependency relationship data indicates that the second element type corresponding to the index value is a function, content in the index value (that is, value) is extracted, and forcibly transformed into a function type defined by the runtime environment, a jump is performed to a function pointer, and a function corresponding to the function pointer is executed. In another example, when the dependency relationship data indicates that the second element type corresponding to the index value is the method of Objective-C, a character string including a method type, a class name, and a method name written during compilation is parsed to obtain a class name character string and a method name character string. Corresponding methods for corresponding classes are found by using an Objective-C runtime environment, and combined into a predefined object, and then the predefined object is returned to the first element. In this way, the first element may obtain relevant information about a method through the object to perform the method. In another example, when the dependency relationship data indicates that the second element type corresponding to the index value is a character string, the index value written during compilation is a pointer of the character string. The runtime environment may find, according to the pointer of the character string, content obtained after the character string is encoded, may obtain the written character string information by decoding the content in a corresponding encoding manner, and then return the character string information to the first element. In another example, when the dependency relationship data indicates that the second element type corresponding to the index value is a class of Objective-C, the index value written during compilation is a character string having a class name. After parsing the character string, the runtime environment using Objective-C returns the class corresponding to the character string to the first element.

For example, the first element is a function A in the current program. The second element is a function B. The function B is in a dynamic library. The function A needs to call the function B during an execution process. That is, the function A depends on the function B. The function A and the function B negotiate to obtain the index key keyA corresponding to the function A. When the program calls the function A, the runtime environment loads the dependency relationship data corresponding to the function A written into a preset binary segment into the internal memory by calling a binary segment reading function, then parses the dependency relationship data loaded into the internal memory according to a predefined data format of the dependency relationship data, and determines index keys included in the dependency relationship data, index values corresponding to the index keys, second element types corresponding to the index values, and an identifier indicating whether the index values are an array. In this embodiment, the index key keyA, and an index value, for example, valueB, corresponding to keyA are obtained after parsing, typeB represents that the index value corresponds to a function type, and isArray=0 represents that valueB is non-array. Then, the runtime environment calls the function B based on the index value.

In this embodiment, the program calling decoupling method is described by using the iOS platform as an example. The program calling decoupling method of the present disclosure is further applicable to other platforms, for example, an Android platform and a Windows platform. Compilation directives called by different platforms during writing and reading are approximately the same. For example, iOS uses compilation directives of a Clang compiler, and other platforms use compilation directives of a compiler such as GCC or G++ of GNU to achieve the same effect.

In the program calling decoupling method in the embodiments of the present disclosure, the dependency relationship data associating the index key with the index value corresponding to the second element is generated according to the index key corresponding to the first element and the second element on which the first element depends in the program. Then, the dependency relationship data is written into the binary data generated after the program is compiled. In an execution process of the program, the dependency relationship data in the binary data of the program is loaded into the runtime environment in response to the calling to the first element in the program. The index value associated with the index key corresponding to the first element is obtained from the dependency relationship data through the runtime environment, and the second element corresponding to the index value is called. The dependency relationship data of the program during running is written into binary data of the program in advance. Therefore, the dependency relationship data is loaded only when elements having a dependency relationship need to be called, thereby effectively shortening the startup time of the program, and effectively improving the startup efficiency of the program.

+load performs undifferentiated full loading when the program starts, and many dependencies that are not on a critical startup path are also executed and loaded at this moment, causing an unnecessary waste. In the program calling decoupling method of the present disclosure, data writing during compilation is fully utilized, and a correspondence between a method and data that need to be executed and index keys is made. When the program is executed until a corresponding index key needs to be loaded, a corresponding function is executed or corresponding data is returned, to avoid an unnecessary waste, and greatly reduce the startup time of the program. Using an example in which 2000 functions need to be decoupled, the 2000 functions are decoupled by using the program calling decoupling method in the present disclosure. Compared with the +load method, the execution time saved by the program calling decoupling method is 80% of the execution time in the +load method.

In addition, +load registers dependency or decoupling functions during startup, and can only implement function decoupling, while the present disclosure may not only implement decoupling during function calling, but also implement decoupling of method data, class data, and character data, and has more application scenarios.

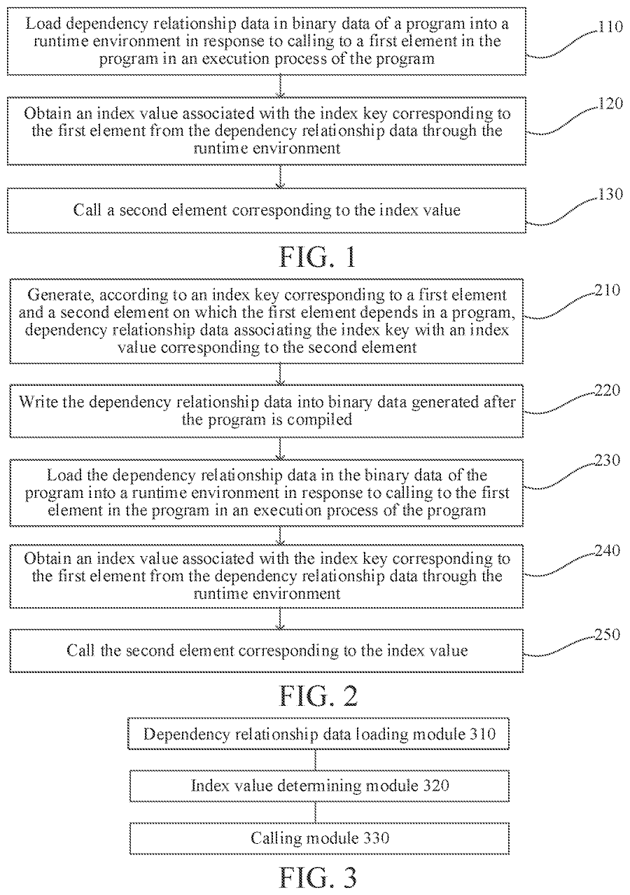

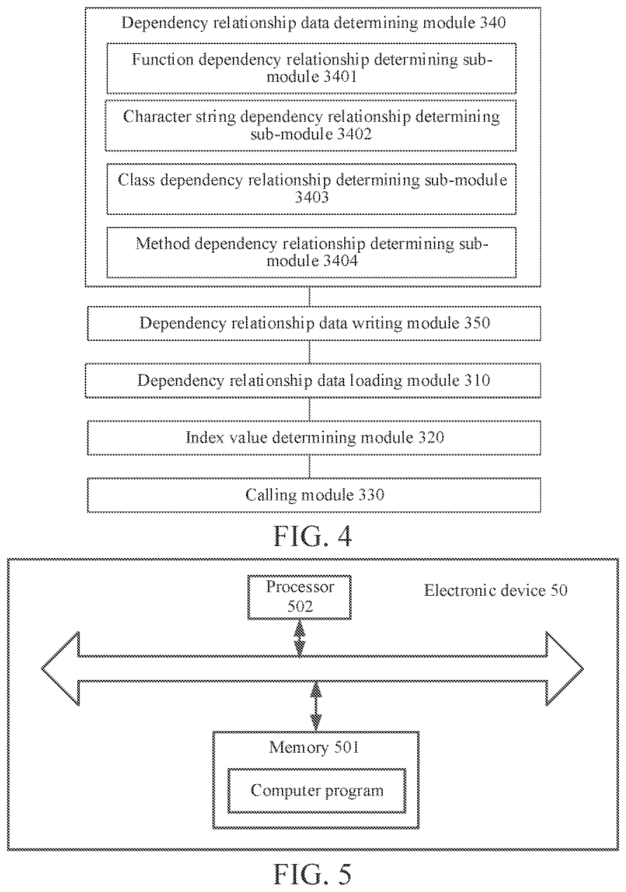

A program calling decoupling apparatus disclosed in this embodiment is shown in FIG. 3. A program has corresponding binary data (that is, the program corresponds to binary data). The binary data includes dependency relationship data. The apparatus includes: a dependency relationship data loading module 310, an index value determining module 320, and a calling module 330.

The dependency relationship data loading module 310 is configured to load the dependency relationship data in the binary data of the program into a runtime environment in response to calling to a first element in the program in an execution process of the program, where the dependency relationship data at least includes an index key corresponding to the first element, and an index value corresponding to a second element, and the first element depends on the second element. The index value refers to an index value associated with the index key.

The index value determining module 320 is configured to obtain the index value associated with the index key corresponding to the first element from the dependency relationship data loaded by the dependency relationship data loading module 310 through the runtime environment. The index value corresponds to the second element, and the first element depends on the second element.

The calling module 330 is configured to call the second element corresponding to the index value determined by the index value determining module 320.

In an embodiment, as shown in FIG. 4, the apparatus further includes a dependency relationship data determining module 340 and a dependency relationship data writing module 350. The dependency relationship data determining module 340 is configured to generate, according to the index key corresponding to the first element and the second element on which the first element depends in the program, the dependency relationship data associating the index key with the index value corresponding to the second element. The dependency relationship data writing module 350 is configured to write the dependency relationship data determined by the dependency relationship data determining module 340 into binary data generated after the program is compiled.

In an embodiment, the dependency relationship data writing module 350 is further configured to write the dependency relationship data into the binary data generated after the program is compiled by using a writing method for calling a binary segment through a compilation directive.

In an embodiment, the dependency relationship data further includes the type of the second element. As shown in FIG. 4, the dependency relationship data determining module 340 includes at least one of the following sub-modules: a function dependency relationship determining sub-module 3401, a character string dependency relationship determining sub-module 3402, a class dependency relationship determining sub-module 3403, and a method dependency relationship determining sub-module 3404.

The function dependency relationship determining sub-module 3401 is configured to determine a pointer of the second element as the index value of the second element if the second element is a function.

The character string dependency relationship determining sub-module 3402 is configured to determine the second element as the index value of the second element if the second element is a character string.

The class dependency relationship determining sub-module 3403 is configured to determine a name of the second element as the index value of the second element if the second element is a class.

The method dependency relationship determining sub-module 3404 is configured to determine a character string obtained through a system macro as the index value of the second element if the second element is a method of Objective-C.

The apparatus disclosed in this embodiment is configured to perform the steps of the program calling method described in the foregoing embodiments. For the specific implementation of each module of the apparatus, refer to the corresponding steps in FIG. 1 and FIG. 2, for example. Details are not described herein again.

In the program calling decoupling apparatus in the embodiments of the present disclosure, the dependency relationship data determining module generates, according to the index key corresponding to the first element and the second element on which the first element depends in the program, the dependency relationship data associating the index key with the index value corresponding to the second element, and then the dependency relationship data writing module writes the dependency relationship data into the binary data generated after the program is compiled. In an execution process of the program, the dependency relationship data loading module loads the dependency relationship data in the binary data of the program into the runtime environment in response to the calling to the first element in the program. The index value determining module obtains the index value associated with the index key corresponding to the first element from the dependency relationship data through the runtime environment, and the calling module calls the second element corresponding to the index value. In the program calling decoupling method in the embodiments of the present disclosure, dependency relationship data of the program during running is written into binary data of the program in advance. Therefore, the dependency relationship data is loaded only when elements having a dependency relationship need to be called, thereby effectively shortening the startup time of the program, and effectively improving the startup efficiency of the program.

+load performs undifferentiated full loading when the program starts, and many dependencies that are not on a critical startup path are also executed and loaded at this moment, causing an unnecessary waste. In the program calling decoupling apparatus of the present disclosure, data writing during compilation is fully utilized, and a correspondence between a method and data that need to be executed and index keys is made. When the program is executed until a corresponding index key needs to be loaded, a corresponding function is executed or corresponding data is returned, to avoid an unnecessary waste, and greatly reduce the startup time of the program.

According to one aspect, a program calling method is provided. The program corresponds to binary data and the binary data comprises dependency relationship data. The method comprising:

loading the dependency relationship data in the binary data of the program into a runtime environment in response to calling to a first element in the program in an execution process of the program, wherein the dependency relationship data at least comprises an index key corresponding to the first element and an index value associated with the index key;

obtaining the index value associated with the index key from the dependency relationship data through the runtime environment, the index value corresponding to a second element, and the first element depending on the second element; and

calling the second element corresponding to the index value.

In one embodiment, before the loading the dependency relationship data in the binary data of the program into a runtime environment in response to calling to a first element in the program in an execution process of the program, the method further comprises:

generating, according to the index key corresponding to the first element and the second element on which the first element depends in the program, the dependency relationship data associating the index key with the index value corresponding to the second element; and

writing the dependency relationship data into binary data generated after the program is compiled.

In another embodiment, the writing the dependency relationship data into binary data generated after the program is compiled comprises: writing the dependency relationship data into the binary data generated after the program is compiled by using a writing method for calling a binary segment through a compilation directive.

In another embodiment, wherein the dependency relationship data further comprises a type of the second element, and

if the second element is a function, a pointer of the second element is used as the index value corresponding to the second element;

if the second element is a character string, the second element itself is used as the index value corresponding to the second element;

if the second element is a class, a name of the second element is used as the index value corresponding to the second element; and

if the second element is a method of Objective-C, a character string obtained through a system macro is used as the index value corresponding to the second element.

In another embodiment, the dependency relationship data further comprises a Boolean value indicating whether the second element is an array, and

if the Boolean value is a specific value, it indicates that the second element is an array, and there are a plurality of index values corresponding to the second element.

In another embodiment, the step of loading the dependency relationship data in the binary data of the program into a runtime environment in response to calling to a first element in the program in an execution process of the program comprises:

obtaining an operation of calling the first element in the program; and

obtaining the dependency relationship data in the binary data of the program in response to the operation through a preset binary segment reading function.

Correspondingly, as shown in FIG. 5, the present disclosure further provides an electronic device 50. The electronic device 50 includes a memory 501 and a processor 502.

The memory 501 stores a computer program runnable on the processor 502, and the processor 502, when executing the computer program, performs the program calling decoupling method described in the foregoing embodiments. The electronic device may be a personal computer (PC), a mobile terminal, a personal digital assistant, a tablet computer, or the like.

The present disclosure further provides a computer-readable storage medium, storing a computer program. The program calling decoupling method described in the foregoing embodiments is performed when the computer program is executed by a processor.

In an exemplary embodiment, a computer program product is provided, including one or more instructions, the one or more instructions, when executed by a processor of the electronic device, may perform the program calling method provided in the foregoing embodiments.

The embodiments in this specification are all described in a parallel manner, each embodiment focuses on a difference from other embodiments, and for same or similar parts in the embodiments, reference may be made to these embodiments. The apparatus embodiments are substantially similar to the method embodiments and therefore are only briefly described, and reference may be made to the method embodiments for the corresponding sections.

The program calling decoupling method and apparatus provided in the present disclosure are described in detail above. The principle and implementations of the present disclosure are described herein by using specific examples. The descriptions of the foregoing embodiments are merely used for helping understand the method and core ideas of the present disclosure. In addition, a person of ordinary skill in the art can make variations to the present disclosure in terms of the specific implementations and application scopes according to the ideas of the present disclosure. Therefore, the content of this specification shall not be construed as a limit on the present disclosure.

Through the description of the foregoing implementations, a person skilled in the art may clearly understand that the implementations may be implemented by software in addition to a necessary universal hardware platform, or by hardware. Based on such an understanding, the foregoing technical solutions essentially or the part contributing to the related art may be implemented in the form of a software product. The computer software product is stored in a computer-readable storage medium, such as a ROM/RAM, a magnetic disk, or an optical disc, and includes several instructions for instructing a computer device (which may be a personal computer, a server, a network device, or the like) to perform the methods described in the embodiments or some parts of the embodiments.

1. A program calling method, a program corresponding to binary data, the binary data comprising dependency relationship data, the method comprising:
loading the dependency relationship data in the binary data of the program into a runtime environment in response to calling to a first element in the program in an execution process of the program, wherein the dependency relationship data at least comprises an index key corresponding to the first element and an index value associated with the index key;
obtaining the index value associated with the index key from the dependency relationship data through the runtime environment, the index value corresponding to a second element, and the first element depending on the second element; and
calling the second element corresponding to the index value.

2. The method according to claim 1, wherein before the loading the dependency relationship data in the binary data of the program into a runtime environment in response to calling to a first element in the program in an execution process of the program, the method further comprises:
generating, according to the index key corresponding to the first element and the second element on which the first element depends in the program, the dependency relationship data associating the index key with the index value corresponding to the second element; and
writing the dependency relationship data into binary data generated after the program is compiled.

3. The method according to claim 2, wherein the writing the dependency relationship data into binary data generated after the program is compiled comprises:
writing the dependency relationship data into the binary data generated after the program is compiled by using a writing method for calling a binary segment through a compilation directive.

4. The method according to claim 1, wherein the dependency relationship data further comprises a type of the second element, and
if the second element is a function, a pointer of the second element is used as the index value corresponding to the second element;
if the second element is a character string, the second element itself is used as the index value corresponding to the second element;
if the second element is a class, a name of the second element is used as the index value corresponding to the second element; and
if the second element is a method of Objective-C, a character string obtained through a system macro is used as the index value corresponding to the second element.

5. The method according to claim 1, wherein the dependency relationship data further comprises a Boolean value indicating whether the second element is an array, and
if the Boolean value is a specific value, it indicates that the second element is an array, and there are a plurality of index values corresponding to the second element.

6. The method according to claim 1, wherein the step of loading the dependency relationship data in the binary data of the program into a runtime environment in response to calling to a first element in the program in an execution process of the program comprises:
obtaining an operation of calling the first element in the program; and
obtaining the dependency relationship data in the binary data of the program in response to the operation through a preset binary segment reading function.

7-12. (canceled)

13. An electronic device, comprising a memory and a processor, the memory storing a computer program runnable on the processor, the program corresponding to binary data, the binary data comprising dependency relationship data, and the processor, when executing the program, performing the following operations:
loading the dependency relationship data in the binary data of the program into a runtime environment in response to calling to a first element in the program in an execution process of the program, wherein the dependency relationship data at least comprises an index key corresponding to the first element and an index value associated with the index key;
obtaining the index value associated with the index key from the dependency relationship data through the runtime environment, the index value corresponding to a second element, the first element depending on the second element; and
calling the second element corresponding to the index value.

14. A computer-readable storage medium, the computer-readable storage medium storing a computer program, the program corresponding to binary data, the binary data comprising dependency relationship data, and the following operations being performed when the program is executed by a processor:
loading the dependency relationship data in the binary data of the program into a runtime environment in response to calling to a first element in the program in an execution process of the program, wherein the dependency relationship data at least comprises an index key corresponding to the first element and an index value associated with the index key;
obtaining the index value associated with the index key from the dependency relationship data through the runtime environment, the index value corresponding to a second element, the first element depending on the second element; and
calling the second element corresponding to the index value.

15. The electronic device according to claim 13, wherein the processor, when executing the program, performs the following operations:
generating, according to the index key corresponding to the first element and the second element on which the first element depends in the program, the dependency relationship data associating the index key with the index value corresponding to the second element; and
writing the dependency relationship data into binary data generated after the program is compiled.

16. The electronic device according to claim 15, wherein the processor, when executing the program, performs the following operations:
writing the dependency relationship data into the binary data generated after the program is compiled by using a writing method for calling a binary segment through a compilation directive.

17. The electronic device according to claim 13, wherein the dependency relationship data further comprises a type of the second element,
if the second element is a function, a pointer of the second element is used as the index value corresponding to the second element;
if the second element is a character string, the second element itself is used as the index value corresponding to the second element;
if the second element is a class, a name of the second element is used as the index value corresponding to the second element; and
if the second element is a method of Objective-C, a character string obtained through a system macro is used as the index value corresponding to the second element.

18. The electronic device according to claim 13, wherein the dependency relationship data further comprises a Boolean value indicating whether the second element is an array, and
if the Boolean value is a specific value, it indicates that the second element is an array, and there are a plurality of index values corresponding to the second element.

19. The electronic device according to claim 13, wherein the processor, when executing the program, performs the following operations:
obtaining an operation of calling the first element in the program; and
obtaining the dependency relationship data in the binary data of the program in response to the operation through a preset binary segment reading function.

20. The storage medium according to claim 14, wherein the program, when executed by the processor, performs the following operations:
generating, according to the index key corresponding to the first element and the second element on which the first element depends in the program, the dependency relationship data associating the index key with the index value corresponding to the second element; and
writing the dependency relationship data into binary data generated after the program is compiled.

21. The storage medium according to claim 20, wherein the program, when executed by the processor, performs the following operation:
writing the dependency relationship data into the binary data generated after the program is compiled by using a writing method for calling a binary segment through a compilation directive.

22. The storage medium according to claim 14, wherein the dependency relationship data further comprises a type of the second element, and
if the second element is a function, a pointer of the second element is used as the index value corresponding to the second element;
if the second element is a character string, the second element is used as the index value corresponding to the second element;
if the second element is a class, a name of the second element is used as the index value corresponding to the second element; and
if the second element is a method of Objective-C, a character string obtained through a system macro is used as the index value corresponding to the second element.

23. The storage medium according to claim 14, wherein the dependency relationship data further comprises a Boolean value indicating whether the second element is an array, and
if the Boolean value is a specific value, it indicates that the second element is an array, and there are a plurality of index values corresponding to the second element.

24. The storage medium according to claim 14, wherein the program, when executed by the processor, performs the following operations:
obtaining an operation of calling the first element in the program; and
obtaining the dependency relationship data in the binary data of the program in response to the operation through a preset binary segment reading function.
